(19) United States
(12) Patent Application Publication
(10) Pub. No.: US 2014/0123392 A1
(43) Pub. Date: May 8, 2014

(54) Bolt Attachment for Electric Bed Bedboard

(71) Applicant: HUAFENG SHAN, Jiaxing City (CN)

(72) Inventor: HUAFENG SHAN, Jiaxing City (CN)

(21) Appl. No.: 13/907,751

(22) Filed: May 31, 2013

(30) Foreign Application Priority Data
Nov. 6, 2012 (CN) 201220579637.7

(51) Int. Cl. A61G 7/015

(52) U.S. Cl. CPC A61G 7/015
USPC 5/618

(57) ABSTRACT

The present invention discloses a bolt attachment structure of an electric bed bed board, such that the fixed structure of the lock in the axial direction of the block has a chute and one end of the through hole of the top surface has a lock chute inside the fixed block. A spring is located in the countersunk hole, whereby the other end of the fixed block is covered. Multiple hooks are located at the bottom of the two pieces of wood. Furthermore, these two pieces of wood are embedded in the mattress where there are pluralities of locking positions. The bolt attachment structure allows reliable connection to the electric bed bed board. This positioning prevents the mattress from slipping and improves the overall comfort of the electric bed.

This application is being filed within 12 months of the filing date of its parent application and accordingly claims Paris Convention priority from China patent application 201220579637.7 filed Nov. 6, 2012 entitled Bolt Attachment for Electric Bed Bedboard by same inventor Shan, Huafeng, the disclosure of which is incorporated herein by reference.

### FIELD OF THE INVENTION

The present invention is in the field of bolt attachment structures for electric bed bedboards.

### DISCUSSION OF RELATED ART

An average person spends about a third of their life sleeping. Thus, more and more attention has been on achieving quality sleep by choosing the right bed that can bring people comfortable and healthy sleep. To meet user needs, various types of electric beds came into widespread usage.

The traditional electric bed bed board angle adjustment that allows the bedboard to rise in the bedplate has a mattress that easily slips from the foot of the bed due to the lack of friction in the bed board. To solve this technical problem, the angle of the electric bed may be adjusted so that it is installed at the foot of the bed frame above the mattress. In the process of rising and lowering, the bed frame may have a barrier so that slipping is prevented. There are some shortcomings to this approach, such as the foot of the bed parts slumping and not staying still, which affects the overall appearance and performance of the electric bed. Also, mattresses are deformed by the frame when the bed board is lifted several times. Mattress and mattress displacement may cause the bedplate to rise. There is no guarantee that the mattress and the bedplate is a good fit in the S-shaped angled profile. These shortcomings reduce the comfort of the electric bed, and hinder the beneficial effects of an electric bed.

Traditional electric beds have a hinged multi-piece bedplate. A variety of different traditional electric beds have been patented such as inventor David Hensley's articulating bed frame U.S. Pat. No. 6,006,379 issued Dec. 28, 1999, the disclosure of which is incorporated herein by reference. The typical bed having four planks hinged to each other may have poor connection between the mattress and the bed boards. Bedboards are also called bedplates and they are typically hinged together including: a head and back support board; a seat support board; a thigh support board; and a calf support board.

### SUMMARY OF THE INVENTION

A bolt attachment structure for an electric bed bedboard has a mattress. A bedboard underneath the mattress supports the mattress. An attachment mechanism includes a fixed block with a chute inside the fixed block formed along an axial direction of the fixed block. A through hole is formed at a first end of the fixed block. The through hole is on a top surface of the fixed block. The through hole communicates to the chute inside the fixed block. A latch has a countersunk hole. The counter sinkhole has a spring located at least partially within the countersunk hole. A cover covers a second end of the fixed block. The cover abuts the spring. A plank is attached to a mattress lower surface. A hook is mounted to an underside of the plank. The hook is located so that it lodges in the through hole of the fixed block, and the bolt attachment structure allows releasable connection between the mattress and bed board.

Optionally, the bolt attachment structure for an electric bed bedboard has a plank that is made of wood. A pair of planks can be embedded in the mattress. A plurality of locking points can be aligned with to a plurality of hooks configured to attach to two planks. The countersunk hole is on a vertical surface of the latch and the spring is bounded between the cover plate and the countersunk hole. An end of the spring biases the latch to engage the hook at the through hole of the fixed block. A top surface of plank is embedded in the mattress. The bolt attachment structure includes four latches and four hooks where a plurality of hook positions match a plurality of locking points. The latch is connected to a bolt, and the spring can be a compression spring. The cover is a flat metal member and the attachment mechanism has a handle attached to the bolt. The bolt is connected to the latch and the an external thread can be formed on the bolt. The cover has a threaded hole that engages with the external thread formed on the bolt. The bolt is attached to the second end of the latch so that rotation of the bolt retracts the latch.

### BRIEF DESCRIPTION OF THE DRAWINGS

FIG. 1 is an exploded view of the present invention.

FIG. 2 is a view of the attachment mechanism lock.

FIG. 3 is a view of the hook.

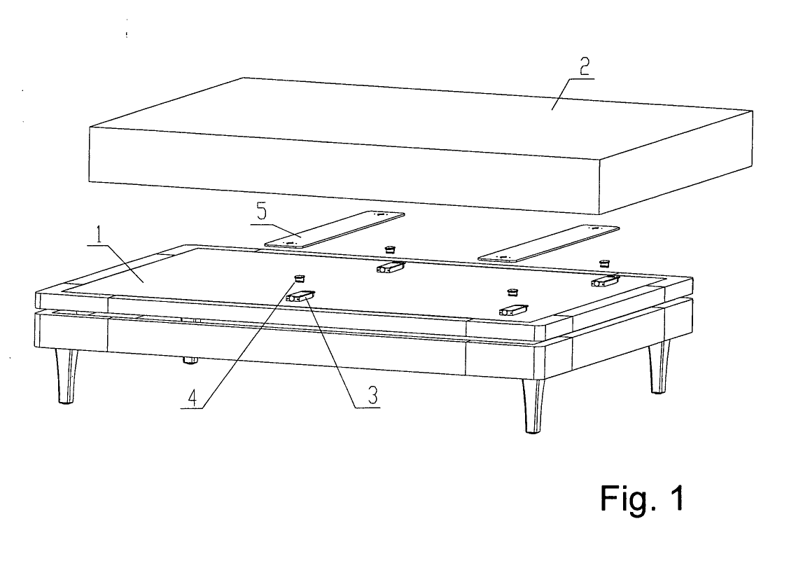

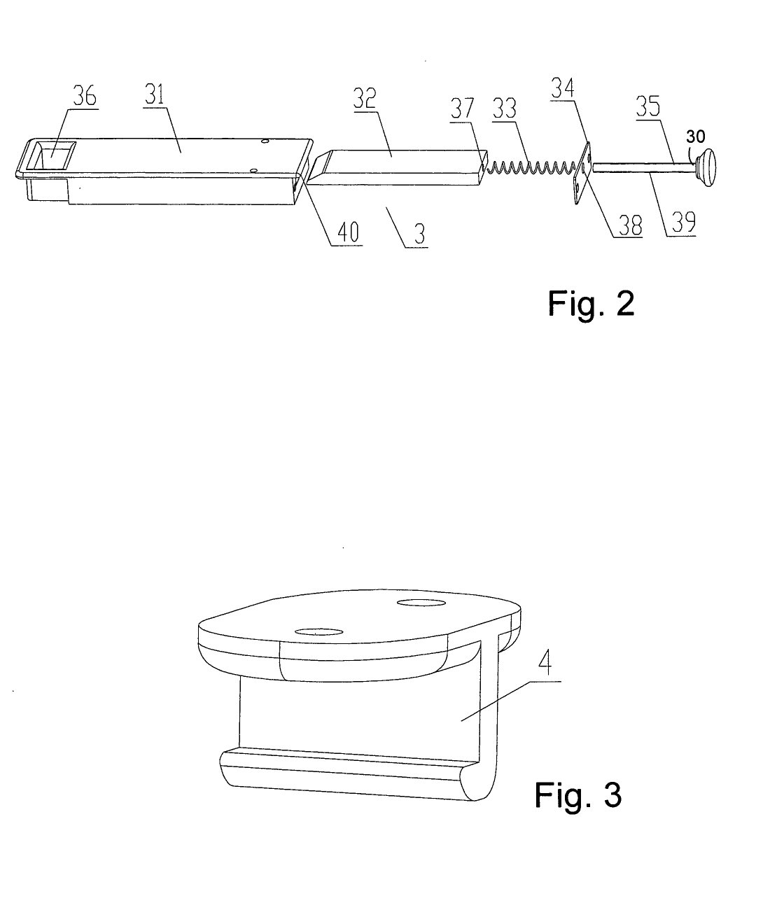

The following call out list of elements can be a useful guide in referencing the element numbers of the drawings.

### 1 Bedboard

### 3 Latch

### 3 Buckle

### 4 Hook

### 5 Boards

30 outer thread

### 31 Fixed Block

### 32 Latch

### 33 Spring

### 34 Cover

### 35 Handle

### 36 Communication Chute

### 37 Countersunk Hole

### 38 Threaded Hole

### 39 Bolt

### 40 Chute

### DETAILED DESCRIPTION OF THE PREFERRED EMBODIMENT

The present invention is a bolt attachment electric bed bed board and includes a plurality of latches 3, a plurality of hooks 4 and two boards 5. The buckle 3 comprises a fixed block 31, a latch 32, spring 33, cover 34 and handle 35. The fixed block 31 is axially provided with a chute 40 where a first end of the through hole of the top surface has a communication to the chute 36. Communication means that the cavity is connected, such that air, water or fluid could flow from the through hole on the top surface to the chute if the latch were removed. The latch 32 is located in fixed block 31 of the chute 40 with a countersunk hole 37 at a second end of the end surface. The spring 33 is located within the countersunk hole 37 meaning that it is located at least partially within the countersunk hole. Cover 34 attaches to the fixed block 31. At the second end, a threaded hole 38 on the cover plate 34, which abuts against the spring 33. Handle 35 is provided with an outer thread 30 and screwed into the threaded hole 38 of the cover 34. A plurality of latches 3 are located at the surface of the bedplate 1, the plurality of hooks 4 are provided in two bottom surface of planks 5 of two boards 5 which are each embedded within mattress 2 and a plurality of hooks 4 positioned to match the positioning of a latch 3, and a plurality of hooks 4 for connecting to the fixed blocks. There are at least four latches 3, and pluralities of hooks 4.

The mechanism of the bolt structure includes attachment operation of the mattress, so that the bed board is fixed in place on top of a bed board surface when multiple hooks are aligned in multiple locking positions. To adjust the mechanism, a user twists the handle so that the bolt located through and passing through the spring receives pressure. The end of the hook is lodged through the top surface of the through hole in one end of the buckle fixing block and shifts to overcome the spring force so the hook end is located entirely at the stationary block. The action and force of the spring sets the hook and latch together to combine them into one member. The latching of the hook fixes the mattress in place due to a combination of hooks, and allows the user to avoid the S-shape poor fit of the mattress to the bedboard/bedplate and improves the overall appearance of the electric bed.

To release the mattress from the bedboard/bedplate, the bolt attachment on the electric bed bed board is unscrewed until the spring force is neutralized to allow a locking into open position where the latch is pulled back to disengage from the hook. The bolt is attached to the latch so that the latch is pulled back when the bolt is screwed back. A user then pulls up the mattress, and removes hook end from the latch. The hooks can be dislodged from the through hole of the lock fixed block.

Planks can be added to this fixed structure and will be embedded by glue adhesive on the mattress and can be set within a sponge block and covered by a sheet of sponge block. The fixed block is attached to the planks preferably by wood screws that can pass through of softer sponge block. The linking relationship of the hook end of hollow sponge block to hook the hook end extending into the fixed block through hole.

Furthermore, according to the size of the bed and considering also the carrying load of the mattress and the bed board, the attachment latch and hook mechanism can be used in at least two pairs comprising at least four or more separate and reliably securing points between the mattresses being flushly attached to the bed board. The attachment structure aims for a more clean appearance, while having easy installation between the mattress and bed board to eliminate mattress sagging and sliding.

The foregoing represents the preferred embodiment of the present invention and the scope of the invention is defined by the following claims which includes reasonably foreseeable and obvious modifications. For example, the bolt can have a smooth portion and a threaded portion so that a user first pulls the bolt backward to retract the latch in a sliding motion and then secondly locks the bolt into position with the threaded portion that engages with the threaded opening of the cover. Also, the bolt can have differing degrees of pitch or other types of commonly known engagement means. The bolt is preferably made in swivel connection with the latch.

1. A bolt attachment structure for an electric bed bedboard comprising:
a. a mattress;
b. a bedboard underneath the mattress and supporting the mattress;
c. an attachment mechanism comprising:
i. a fixed block with a chute inside the fixed block formed along an axial direction of the fixed block;
ii. a through hole formed at a first end of the fixed block, wherein the through hole is on a top surface of the fixed block, wherein the through hole communicates to the chute inside the fixed block;
iii. a latch having a countersunk hole, wherein the counter sinkhole has a spring located at least partially within the countersunk hole;
iv. a cover covering a second end of the fixed block, and wherein the cover abuts the spring;
v. a plank attached to a mattress lower surface;
vi. a hook mounted to an underside of the plank, wherein the hook is located so that it lodges in the through hole of the fixed block, whereby the bolt attachment structure allows releasable connection between the mattress and bed board.

2. The bolt attachment structure for an electric bed bedboard of claim 1, wherein the plank is made of wood.

3. The bolt attachment structure for an electric bed bedboard of claim 1, further comprising a pair of planks embedded in the mattress, wherein there are a plurality of locking points due to a plurality of hooks configured to attach to the pair of planks.

4. The bolt attachment structure for an electric bed bedboard of claim 1, wherein the countersunk hole is on a vertical surface of the latch and wherein spring is bounded between the cover plate and the countersunk hole, wherein an end of the spring biases the latch to engage the hook at the through hole of the fixed block.

5. The bolt attachment structure for an electric bed bedboard of claim 1, wherein a top surface of plank is embedded in the mattress.

6. The bolt attachment structure for an electric bed bedboard of claim 1, wherein the bolt attachment structure includes four latches and four hooks where a plurality of hook positions that match a plurality of locking points.

7. The bolt attachment structure for an electric bed bedboard of claim 1, wherein the latch is connected to a bolt, wherein the spring is a compression spring, wherein the cover is a flat metal member; and wherein the attachment mechanism further comprises a handle attached to the bolt, wherein the bolt is connected to the latch and wherein the attachment mechanism further comprises an external thread formed on the bolt.

8. The bolt attachment structure for an electric bed bedboard of claim 7, wherein the plank is made of wood.

9. The bolt attachment structure for an electric bed bedboard of claim 7, further comprising a pair of planks embedded in the mattress, wherein there are a plurality of locking points due to a plurality of hooks configured to attached to two planks.

10. The bolt attachment structure for an electric bed bedboard of claim 7, wherein the countersunk hole is on a vertical surface of the latch and wherein spring is bounded between the cover plate and the countersunk hole, wherein an end of the spring biases the latch to engage the hook at the through hole of the fixed block.

11. The bolt attachment structure for an electric bed bedboard of claim 7, wherein a top surface of plank is embedded in the mattress.

12. The bolt attachment structure for an electric bed bedboard of claim 7, wherein the bolt attachment structure includes four latches and four hooks where a plurality of hook positions that match a plurality of locking points.

13. The bolt attachment structure for an electric bed bedboard of claim 7, wherein the cover has a threaded hole that engages with the external thread formed on the bolt, wherein the bolt is attached to the second end of the latch so that rotation of the bolt retracts the latch.
